(19) United States
(12) Patent Application Publication
(10) Pub. No.: US 2011/0062316 A1
(43) Pub. Date: Mar. 17, 2011

(54) SCREEN DEVICE WITH LIGHT RECEIVING ELEMENT AND DISPLAY DEVICE WITH POSITION DETECTION FUNCTION

(75) Inventors: Kanechika KIYOSE, Matsumoto (JP); Daisuke NAKANISHI, Matsumoto (JP); Yasunori ONISHI, Shiojiri (JP); Masaki TAKAHASHI, Chino (JP)

(73) Assignee: SEIKO EPSON CORPORATION, Tokyo (JP)

(21) Appl. No.: 12/851,617

(22) Filed: Aug. 6, 2010

(30) Foreign Application Priority Data
Sep. 17, 2009 (JP) 2009-215378

(51) Int. Cl. G06F 3/033

(52) U.S. Cl. 250/221

(57) ABSTRACT

A screen device with a light receiving element, the screen device being used in a display device with a position detection function, the display device forming an intensity distribution of a position detection light on a screen surface side of a screen member, the screen surface side on which an image is visually recognized, the display device detecting the position of an object located on the screen surface side of the screen member by detecting the position detection light reflected from the object, the screen device includes: a screen device main body provided with the screen member; and a light receiving element which is formed of a photodiode or a phototransistor fixed to the screen device main body and directs a light receiving section in a direction along the screen surface outside a screen surface in a state in which the screen member is spread.

### BACKGROUND

1. Technical Field

The present invention relates to a screen device with a light receiving element, the screen device provided with a screen member, and a display device with a position detection function, the display device provided with the screen device with a light receiving element.

2. Related Art

In electronic devices such as cellular telephones, car navigation systems, personal computers, ticket vending machines, and terminals at the banks, a display device with a position detection function, the display device having a touch panel on the front face of an image forming device such as a liquid crystal device, has been recently used. In such a display device with a position detection function, input of information is performed while referring to an image displayed on the image forming device. Such a touch panel is configured as a position detecting device for detecting the position of an object in a detection area (refer to, for example, U.S. Pat. No. 6,927,384 (Patent Document 1)).

In such a position detecting device described in Patent Document 1, alight guide plate is provided on the input operation side of a direct-view-type display panel such as a liquid crystal panel, and a light source, a light receiving element, etc. are disposed on the side of the light guide plate opposite from the input operation side. Then, the position detection light emitted from the light source is made to travel to the input operation side via the light guide plate, and the position detection light reflected from an object is received by the light receiving element.

### SUMMARY

Here, the inventor proposes a display device with a position detection function, the display device which displays an image on a screen member and detects the position of an object on the front side (on the screen surface side) of the screen member. However, in the above-structured display device with a position detection function, a light guide plate often cannot be provided on the front side of the screen member, making it impossible to adopt the structure described in Patent Document 1. Moreover, when the display device is provided with a large image display area such as a screen member, it takes a lot of time to place a light receiving element on the screen member with a high degree of positional accuracy.

An advantage of some aspects of the invention is to provide a screen device with a light receiving element, the screen device which can detect the position of an object on the screen surface side of a screen member, the screen surface side on which an image is visually recognized, and a display device with a position detection function, the display device provided with the screen device with a light receiving element.

According to an aspect of the invention, a screen device which is used in a display device with a position detection function, the display device forming an intensity distribution of a position detection light on a screen surface side of a screen member, the screen surface side on which an image is visually recognized, the display device detecting the position of an object located on the screen surface side of the screen member by detecting the position detection light reflected from the object, the screen device includes: a screen device main body provided with the screen member; and a light receiving element which is formed of a photodiode or a phototransistor fixed to the screen device main body and directs a light receiving section in a direction along the screen surface outside a screen surface in a state in which the screen member is spread.

According to the aspect of the invention, the “screen member” includes a screen member used in an electronic blackboard in addition to a member subjected to irradiation and used in a projection display device. Moreover, the “screen surface side” means a side of the surfaces of the screen member, the side on which an image is displayed, and the “screen surface” means a planar area of the screen member, the area in which an image can be displayed.

In the screen device with a light receiving element, the screen device to which the invention is applied, an intensity distribution of the position detection light is formed by the position detection light emitted to the screen surface side of the screen member, and the light receiving element receives the position detection light reflected from the object. Therefore, when a relationship between the amount of light received by the light receiving element and the intensity distribution of the position detection light is known in advance, it is possible to detect the position of the object. Since such a detection method only requires to form a light intensity distribution of the position detection light on the screen surface side of the screen member and does not necessarily require to dispose a light guide plate on the front side of the screen member, the method is suitable for a display device with a position detection function, the display device displaying an image on the screen member. Furthermore, even when an image is displayed on a relatively large member such as the screen member, since the light receiving element is fixed in advance to the screen device main body itself, it is possible to secure a high degree of positional accuracy between the screen member and the light receiving element without much trouble when the display device with a position detection function is assembled.

According to the aspect of the invention, it is preferable that the screen member pass an infrared light therethrough, and the position detection light be an infrared light passing through the screen member from a back face side of the screen member and traveling to the screen surface side. With this structure, even when the light source for position detection is provided on the side (the back face side) of the screen member opposite from the input operation side, it is possible to form a light intensity distribution of the position detection light on the screen surface side of the screen member. Therefore, this structure has an advantage in that there is no need to provide the light source for position detection or the like on the input operation side (the screen surface side) of the screen member.

According to the aspect of the invention, it is preferable that the screen device include a plurality of light receiving elements, and the plurality of light receiving elements direct the light receiving sections to different areas in the screen surface of the screen member. With this structure, it is possible to perform position detection by dividing an area by the plurality of light receiving elements. Therefore, it is possible to perform position detection reliably in a wide area such as a screen surface of a screen member.

According to the aspect of the invention, it is preferable that the screen surface be rectangular, and the plurality of light receiving elements be provided indifferent positions in a long side direction of the screen surface in an area next to a long side of the screen surface. With such a structure, in any area monitored by the light receiving elements, the distances from the light receiving elements are short. Thus, since an adequate amount of position detection light enters the light receiving elements, it is possible to reduce detection errors.

In this case, it is preferable that the plurality of light receiving elements be provided in an area next to the same long side of the screen surface. With such a structure, the plurality of light receiving elements can be provided so as to be situated close to each other, making it possible to dispose the wiring for the light receiving elements in a narrow area.

According to the aspect of the invention, the screen member having flexibility, for example, is used.

According to the aspect of the invention, it is possible to adopt a structure in which the light receiving element is fixed to the screen surface side of the screen member.

Moreover, when the screen member has flexibility, a structure in which the screen device main body includes a rolling-up device rolling up the screen member and a housing in which the rolling-up device is stored and the light receiving element is fixed to the housing may be adopted.

According to another aspect of the invention, when the screen device with a light receiving element, the screen device to which the invention is applied, is used in a display device with a position detection function, the display device with a position detection function includes: a light source device for position detection forming an intensity distributions of the position detection light in directions intersecting one another at different times on the screen surface side of the screen member; and a position detecting section detecting the position of the object based on a light reception result obtained by the light receiving element.

According to the aspect of the invention, when the screen device with a light receiving element, the screen device provided with a plurality of light receiving elements, is used in a display device with a position detection function, it is preferable that the display device include: a light source device for position detection forming an intensity distributions of the position detection light in directions intersecting one another at different times on the screen surface side of the screen member; and a position detecting section detecting the position of the object based on light reception results of the plurality of light receiving elements, the object including a plurality of objects.

According to the aspect of the invention, it is preferable that the light source device for position detection include a plurality of light sources for position detection, the light sources emitting the position detection light on the back face side of the screen member which has been spread, and a light guide plate disposed on the back face side of the screen member which has been spread, the light guide plate taking in the light emitted from the light sources for position detection and making the light travel to the screen member. With such a structure, only by making part of the plurality of light sources for position detection flash and making the other light sources turn off and changing the combination pattern thereof with time, it is possible to form an intensity distribution of the position detection light on the screen surface side of the screen member in directions intersecting one another at different times.

### BRIEF DESCRIPTION OF THE DRAWINGS

The invention will be described with reference to the accompanying drawings, wherein like numbers reference like elements.

FIGS. 1A and 1B are explanatory diagrams schematically showing the structures of a screen device with a light receiving element, an optical position detecting device, and a display device with a position detection function, the screen device, the optical position detecting device, and the display device to which the invention is applied.

FIGS. 2A and 2B are explanatory diagrams schematically showing the structure of the screen device with a light receiving element, the screen device to which the invention is applied.

FIG. 3 is an explanatory diagram showing, for example, the positional relationship between a screen member and a light receiving element in the screen device with a light receiving element, the screen device to which the invention is applied.

FIGS. 4A to 4C are explanatory diagrams showing a detailed structure of the optical position detecting device formed in the display device with a position detection function, the display device to which the invention is applied.

FIGS. 5A and 5B are explanatory diagrams of another light source device for position detection used in the display device with a position detection function, the display device to which the invention is applied.

### DESCRIPTION OF EXEMPLARY EMBODIMENTS

Next, an embodiment of the invention will be described in detail with reference to the accompanying drawings. Incidentally, the following description will be given on the assumption that an in-plane direction in a detection area is an XY plane in the XYZ orthogonal coordinates, and a direction perpendicular to the in-plane direction in the detection area is a Z-axis direction.

Structures of an Optical Position Detecting Device and a Display Device with a Position Detection Function
Overall Structure of the Display Device with a Position Detection Function

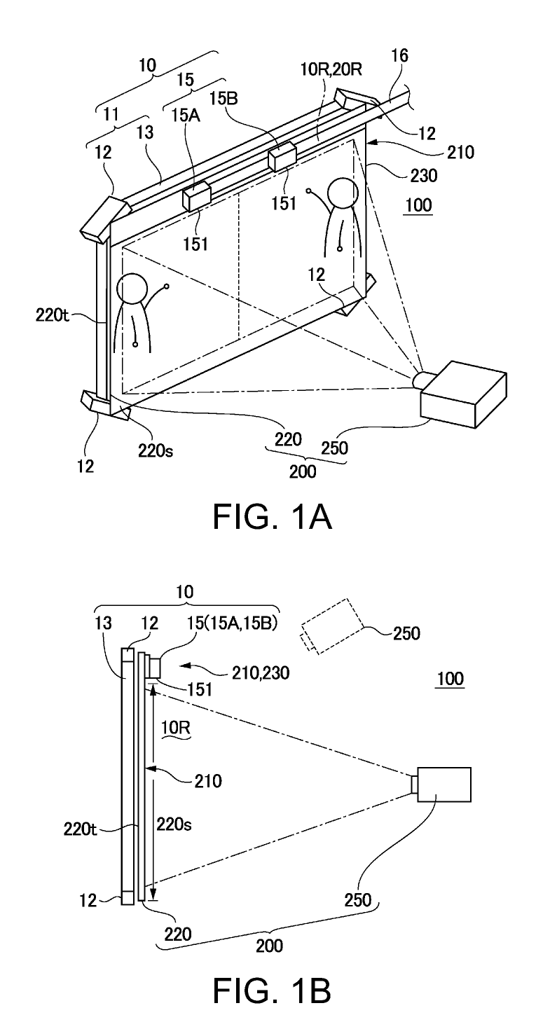

FIGS. 1A and 1B are explanatory diagrams schematically showing the structures of a screen device with a light receiving element, an optical position detecting device, and a display device with a position detection function, the screen device, the optical position detecting device, and the display device to which the invention is applied. FIGS. 1A and 1B are an explanatory diagram schematically showing the principal portions of the display device with a position detection function which are obliquely seen from above and an explanatory diagram showing the principal portions of the display device with a position detection function which are seen from the side, respectively.

A display device 100 with a position detection function shown in FIGS. 1A and 1B includes an optical position detecting device 10 and an image forming device 200. When an object such as a finger is brought close to a detection area 10R based on an image displayed by the image forming device 200, the optical position detecting device 10 detects the planar position (the X coordinate position and the Y coordinate position) of an object Ob.

As will be described in detail later, the optical position detecting device 10 has a light source device 11 for position detection, the light source device 11 provided with a plurality of light sources 12 for position detection which emit a position detection light formed of an infrared light, and a light receiving element 15 with a light receiving section 151 directed to the detection area 10R. To the light receiving element 15, a wiring material 16 such as a lead wire or a flexible wiring substrate is connected. In this embodiment, the light source device 11 for position detection also includes a light guide plate 13 disposed parallel to the XY plane. The light receiving element 15 is formed of a photodiode or a phototransistor.

In this embodiment, the image forming device 200 is of the projection type, and has a screen member 220 disposed over the front face side (the input operation side) of the light guide plate 13 and an image projection device 250 which magnifies and projects the display light onto a screen surface 220s side of the screen member 220, the screen surface 220s side on which an image is visually recognized. An area of the screen member 220 other than an upper end part thereof corresponds to a screen surface 220s on which an image can be displayed, and the image projection device 250 displays an image by using part of the screen surface 220s as an image display area 20R. Moreover, the detection area 10R of the optical position detecting device 10 is set on the screen surface 220s side of the screen member 220, and the light source device 11 for position detection provided with the light guide plate 13 and the light sources 12 for position detection is disposed on the back face 220t side of the screen member 220. In this embodiment, the image display area 20R is an area which substantially overlaps the detection area 10R.

Incidentally, FIGS. 1A and 1B show an example in which the image projection device 250 is placed in front of the screen member 220. However, as indicated by dashed lines in FIG. 1B, the image projection device 250 may project the display light onto the screen member 220 obliquely.

In this embodiment, as the screen member 220, various types of screen members which will be described below can be used, and all of these screen members are made of material that allows the passage of the infrared light. First, as the screen member 220, cloth with the screen surface 220s coated with white paint or a white screen formed of an embossed white vinyl material can be used. Moreover, as the screen member 220, a silver screen having a bright silver color for enhancing light reflectance can be used. Furthermore, as the screen member 220, it is also possible to use a pearl screen with light reflectance enhanced by resinating the surface of cloth forming the screen surface 220s or a piece screen with light reflectance enhanced by applying fine glass powder to the screen surface 220s.

### Structures of the Screen Device and the Light Receiving Element

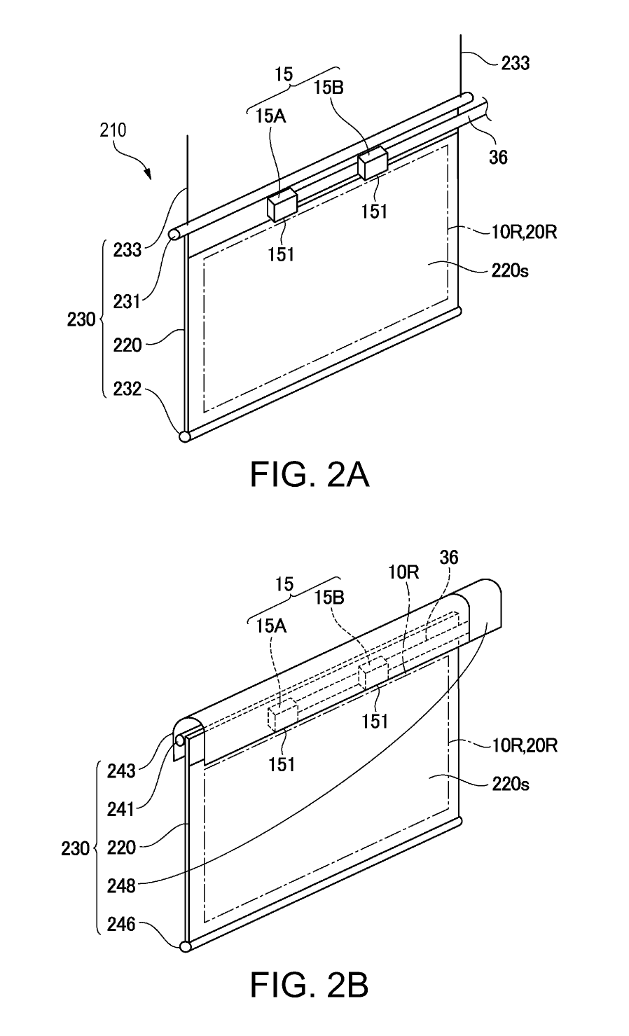

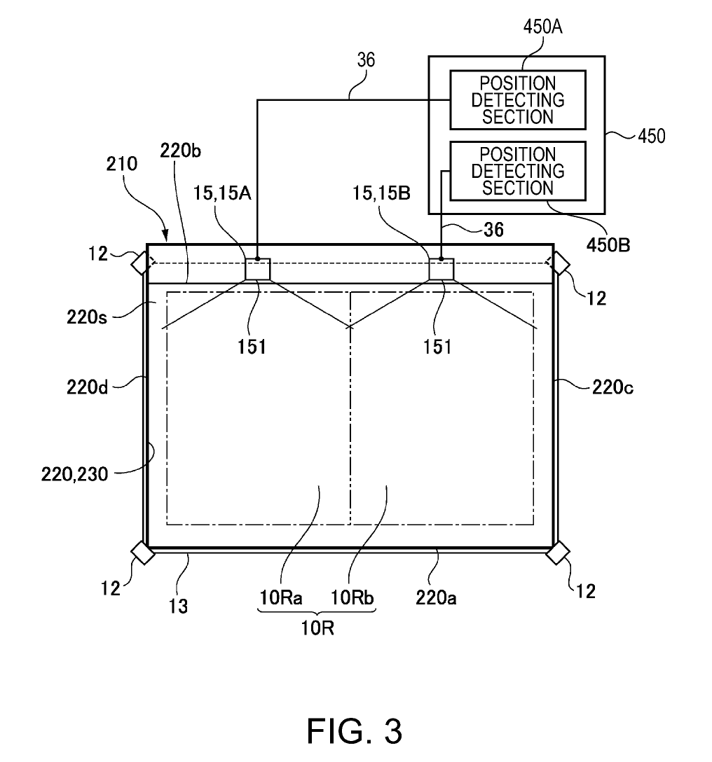

FIGS. 2A and 2B are explanatory diagrams schematically showing the structure of the screen device with a light receiving element, the screen device to which the invention is applied. FIGS. 2A and 2B are an explanatory diagram of a hanging manual screen device with a light receiving element and an explanatory diagram of a motorized screen device with a light receiving element, respectively. FIG. 3 is an explanatory diagram showing, for example, the positional relationship between the screen member 220 and the light receiving element 15 in the screen device with a light receiving element, the screen device to which the invention is applied.

In the optical position detecting device 10 and the display device 100 with a position detection function shown in FIGS. 1A and 1B, as shown in FIGS. 2A and 2B, the screen member 220 and the light receiving element 15 are integrated together into the screen device 210 with a light receiving element. Moreover, in the optical position detecting device 10 and the display device 100 with a position detection function shown in FIGS. 1A and 1B, two light receiving elements 15A and 15B are used as the light receiving element 15.

First, the screen device 210 with a light receiving element shown in FIG. 2A is a hanging manual screen device, and a screen device main body 230 includes a flexible screen member 220, a supporting rod 231 formed as a rail connected to an upper edge of the screen member 220, a weight rod 232 formed as a rail connected to a lower edge of the screen member 220, and cords 233 connected to both ends of the supporting rod 231.

In such a screen device main body 230, the entire part of the screen member 220 other than an upper end part thereof corresponds to the screen surface 220s. On the upper edge side of the screen member 220, the two light receiving elements 15A and 15B serving as the light receiving element 15 are fixed in an area (an area outside the screen surface 220s) sandwiched between the screen surface 220s and the supporting rod 231 by being bonded, for example, to that area directly or via a circuit substrate (not shown) or the like. Moreover, on the upper edge side of the screen member 220, the wiring material 16 electrically connected to the light receiving elements 15A and 15B is also fixed in an area outside the screen surface 220s by being bonded, for example, to that area. In this way, the screen device 210 with a light receiving element, the screen device 210 having the screen device main body 230 provided with the screen member 220, the screen device main body 230 to which the light receiving element 15 (the light receiving elements 15A and 15B) is fixed, is configured. In such a screen device 210 with a light receiving element, on the screen surface 220s side of the screen member 220 in a spread state, the light receiving element 15 (the light receiving elements 15A and 15B) directs the light receiving section 151 from an area outside the screen surface 220s in a direction along the screen surface 220s.

The screen device 210 with a light receiving element shown in FIG. 2B is a motorized screen device, and a screen device main body 230 includes a flexible screen member 220, a rotating shaft 241 connected to an upper edge of the screen member 220, a housing 243 covering the rotating shaft 241, and a weight rod 246 formed as a rail connected to a lower edge of the screen member 220. Moreover, the screen device main body 230 includes a drive unit 248 (a rolling-up device) with a built-in motor on the end of the housing 243. The drive unit 248 is mechanistically connected to the rotating shaft 241. The drive unit 248 pulls the screen member 220 from the housing 243 by rotating the rotating shaft 241 in one direction about an axis and spreads the screen member 220, and stores the screen member 220 in the housing 243 in a rolled-up state by rotating the rotating shaft 241 in the other direction about the axis. In such a structure, of the screen member 220, the part pulled from the housing 243 is used as the screen surface 220s.

In such a screen device main body 230, the two light receiving elements 15A and 15B serving as the light receiving element 15 are fixed on an inner surface of the housing 243 directly or via a circuit substrate (not shown) or the like by being bonded, for example, to that surface. Moreover, the wiring material 16 electrically connected to the light receiving elements 15A and 15B is also fixed on the inner surface of the housing 243 by being bonded, for example, to that surface. In such a way, the screen device 210 with a light receiving element, the screen device 210 having the screen device main body 230 provided with the screen member 220, the screen device main body 230 to which the light receiving element 15 (the light receiving elements 15A and 15B) is fixed, is configured. In such a screen device 210 with a light receiving element, on the screen surface 220s side of the screen member 220 in a spread state, the light receiving element 15 (the light receiving elements 15A and 15B) directs the light receiving section 151 from an area outside the screen surface 220s in a direction along the screen surface 220s.

As shown in FIG. 3, in both of the screen devices 210 with a light receiving element shown in FIGS. 2A and 2B, the two light receiving elements 15A and 15B direct the light receiving sections 151 to different areas in the screen surface 220s on the screen surface 220s side of the screen member 220. Moreover, the screen surface 220a of this embodiment is rectangular, and the two light receiving elements 15A and 15B are provided in different positions in a long side direction of the screen surface 220s in an area corresponding to a long side of the screen surface 220a. More specifically, the screen surface 220a has two long sides 220a and 220b facing each other and two short sides 220c and 220d facing each other, and the two light receiving elements 15A and 15B are provided in different positions in a long side direction in an area corresponding to the same long side 220b of the screen surface. Here, the light receiving elements 15A and 15B are provided in intermediate positions in a long side direction, the intermediate positions of two areas 10Ra and 10Rb, respectively, which are obtained by equally dividing the detection area 10R (the image display area 20R) into two areas in the long side direction. Moreover, the central optical axes of the light receiving elements 15A and 15B extend in a direction perpendicular to the long side 220a.

To the light receiving elements 15A and 15B, a signal processing section 450 is electrically connected, and the signal processing section 450 is provided with two position detecting sections 450A and 450B to which the detection results obtained by the light receiving elements 15A and 15B are input. That is, the signal processing section 450 is provided with the position detecting section 450A performing position detection based on the light reception result obtained by the light receiving element 15A and the position detecting section 450B performing position detection based on the light reception result obtained by the light receiving element 15B. Here, the position detecting sections 450A and 450B perform position detection independently. Therefore, in this embodiment, it is possible to perform position detection in one area 10Ra of the detection area 10R based on the detection result obtained by the light receiving element 15A and perform position detection in the other area 10Rb based on the detection result obtained by the light receiving element 15B.

### Detailed Structure of the Optical Position Detecting Device 10

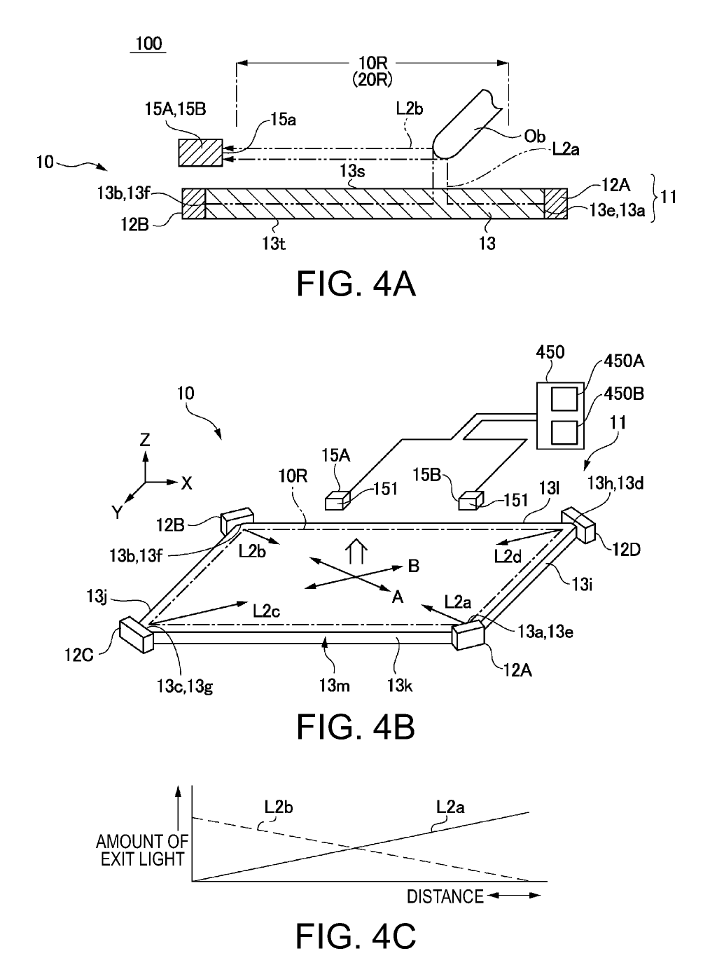

FIGS. 4A to 4C are explanatory diagrams showing a detailed structure of the optical position detecting device 10 to which the invention is applied. FIGS. 4A, 4B, and 4C are respectively an explanatory diagram schematically showing the sectional structure of the optical position detecting device 10, an explanatory diagram showing the structure of the light guide plate 13 etc. used in the optical position detecting device, and an explanatory diagram showing an attenuation state of the infrared light for position detection in the light guide plate 13. Incidentally, in FIGS. 4A to 4C, the Z-axis direction is shown as a vertical direction.

As shown in FIGS. 4A and 4B, in the optical position detecting device 10 of this embodiment, the light source device 11 for position detection includes the light guide plate 13 having a virtually rectangular planar shape. At a side edge face 13m of the light guide plate 13, side portions 13k and 131 corresponding to the long sides face each other in the Y-axis direction, and side portions 13i and 13j corresponding to the short sides face each other in the X-axis direction.

In accordance with the shape of the light guide plate 13, the optical position detecting device 10 has four light sources 12A to 12D for position detection (the light sources 12 for position detection shown in FIGS. 1A and 1B) emitting position detection lights L2a to L2d, and the light guide plate 13 has four light incident sections 13a to 13d at the side edge face 13m, the light incident sections 13a to 13d which the position detection lights L2a to L2d enter. The light guide plate 13 has a light exit surface 13s on one surface thereof (an upper face in the drawing), the light exit surface 13s from which the position detection lights L2a to L2d which have propagated through the light guide plate 13 exit, and the light exit surface 13s and the side edge face 13m are perpendicular to each other. The optical position detecting device 10 includes the light receiving element 15 (the light receiving elements 15A and 15B) with the light receiving section 151 directed to the detection area 10R.

In this embodiment, all of the four light sources 12A to 12D for position detection and the four light incident sections 13a to 13d are provided at corner portions 13e, 13f, 13g, and 13h of the light guide plate 13. The light sources 12A to 12D for position detection are disposed so as to face the light incident sections 13a to 13d, and preferably to be brought into intimate contact with the light incident sections 13a to 13d.

The light guide plate 13 is formed of a transparent resin plate such as polycarbonate or acrylic resin. In the light guide plate 13, on the light exit surface 13s or a back face 13t on the opposite side of the light exit surface 13s, a surface asperity structure, a prism structure, a scattering layer (not shown), or the like, is provided. By such a light scattering structure, the light which enters the light guide plate 13 at the light incident sections 13a to 13d and propagates through the light guide plate 13 is gradually deflected while moving in the propagation direction, and exits from the light exit surface 13s. Incidentally, on the light exit side of the light guide plate 13, an optical sheet such as a prism sheet or a light scattering plate is sometimes placed when necessary in order to make the position detection lights L2a to L2d uniform.

The light sources 12A to 12D for position detection are each formed of a light emitting element such as an LED (light emitting diode), and emit the position detection lights L2a to L2d formed of the infrared light as a diverging light according to a drive signal output from a drive circuit (not shown). The type of the position detection lights L2a to L2d is not particularly limited, and the position detection lights L2a to L2d only have to have a wavelength distribution which is different from that of a visible light or have a light emission mode which is different from that of a visible light by being modulated such as being made to flash. Moreover, it is preferable that the position detection lights L2a to L2d have a wave range in which these lights are efficiently reflected from the object Ob such as a finger or a touch pen. Therefore, when the object Ob is a human body such as a finger, it is preferable that the position detection lights L2a to L2d be infrared radiation (in particular, near infrared radiation near a visible light region; for example, a region near 850 nm in wavelength) with high reflectivity on the surface of the human body or be 950 nm.

The light sources 12A to 12D for position detection essentially include multiple light sources, and are configured so as to emit the position detection lights L2a to L2d from different positions. Of the four light sources 12A to 12D for position detection, a pair of light sources for position detection at the opposing corners forms a first light source, and the other pair of light sources for position detection forms a second light source. Moreover, of the four light sources 12A to 12D for position detection, a pair of adjacent light sources for position detection may form a first light source pair, and the other pair of light sources for position detection may form a second light source pair.

The detection area 10R is a planar area from which the position detection lights L2a to L2d travel to the observer's side (the operation side), the area in which the light reflected from the object Ob can be generated. In this embodiment, the planar shape of the detection area 10R is a rectangle, and the light receiving element 15 (the light receiving elements 15A and 15B) is disposed roughly in the center of one side portion of the four side portions of the detection area 10R in the length direction. In the detection area 10R, the interior angle at a corner portion formed by the adjacent sides is 90 degrees, and such an interior angle is assumed to be the same angle as the interior angle at each of the corner portions 13e to 13h of the light guide plate 13.

In the above-structured display device 100 with a position detection function, the position detection light L2a and the position detection light L2b exit from the light exit surface 13s while propagating through the light guide plate 13 in opposite directions in the direction of an arrow A. Moreover, the position detection light L2c and the position detection light L2d exit from the light exit surface 13s while propagating through the light guide plate 13 in opposite directions in the direction (the direction of an arrow B) intersecting the direction of the arrow A. Therefore, as shown by the solid line in FIG. 4C, the amount of the position detection light L2a exiting from the light guide plate 13 and traveling to the detection area 10R has an intensity distribution which linearly attenuates with distance from the light source 12A for position detection. Moreover, as shown by the dotted line in FIG. 4C, the amount of the position detection light L2b traveling to the detection area 10R has an intensity distribution which linearly attenuates with distance from the light source 12B for position detection.

### Basic Principles for Detection of XY Coordinates

A method for obtaining the XY coordinates of the object Ob based on the detection by the light receiving element 15 will be described. There are various methods for obtaining the positional information. For example, there is a method by which the positional coordinates in the direction in which corresponding two light sources are connected are obtained by obtaining the ratio between the attenuation coefficients of the two position detection lights based on the ratio between the detected amounts of the two position detection lights and obtaining the distance of propagation of the two position detection lights based on the obtained ratio between the attenuation coefficients. Moreover, there is a method by which the positional coordinates in the direction in which corresponding two light sources are connected based on the absolute value of the difference between the detected amounts of two position detection lights by obtaining the difference. In both methods, there are a method by which the output value from the light receiving element 15 is directly used for calculation, a method by which the time from when electric power is stored or discharged in or from a condenser via the light receiving element 15 till when a voltage between two terminals of the condenser reaches a predetermined voltage is used for calculation, and other methods. In both cases, the properties which will be described below are used.

First, in the display device 100 with a position detection function, the position detection lights L2a to L2d emitted from the light sources 12A to 12D for position detection gradually exit from the light exit surface 13s while propagating through the light guide plate 13 after entering the light guide plate 13 from the light incident sections 13a to 13d, respectively. As a result, the position detection lights L2a to L2d are emitted from the light exit surface 13s in the form of a sheet.

For example, the position detection light L2a is gradually emitted from the light exit surface 13s while propagating through the light guide plate 13 from the light incident section 13a toward the light incident section 13b. Likewise, the position detection lights L2c and L2d are gradually emitted from the light exit surface 13s while propagating through the light guide plate 13. Therefore, when the object Ob such as a finger is placed in the detection area 10R, the position detection lights L2a to L2d are reflected from the object Ob, and part of the reflected light is detected by the light receiving element 15.

Here, it is considered that, as shown by the solid line in FIG. 4C, the amount of the position detection light L2a traveling to the detection area 10R attenuates linearly with distance from the light source 12A for position detection, and, as shown by the dotted line in FIG. 4C, the amount of the position detection light L2b traveling to the detection area 10R attenuates linearly with distance from the light source 12B for position detection.

Moreover, let a control variable (for example, the amount of current), a conversion coefficient, and the amount of emitted light of the light source 12A for position detection be Ia, k, and Ea and a control variable (the amount of current), a conversion coefficient, and the amount of emitted light of the light source 12B for position detection be Ib, k, and Eb, then the following equations are held.

Ea=k·Ia, and

Eb=k·Ib

In addition, let an attenuation coefficient and the amount of detected light of the position detection light L2a be fa and Ga and an attenuation coefficient and the amount of detected light of the position detection light L2b be fb and Gb, then the following equations are held.

Ga=fa·Ea=fa·k·a, and

Gb=fb·Eb=fb·k·Ib

Therefore, when Ga/Gb which is the ratio between the amounts of detected light of the two position detection lights can be detected by the light receiving element 15, Ga/Gb=(fa·Ea)/(fb·Eb)=(fa/fb)·(Ia/Ib) holds. Thus, the ratio fa/fb between the attenuation coefficients is determined when values corresponding to the ratio Ea/Eb between the amounts of emitted light and the ratio Ia/Ib between the control variables are obtained. When the ratio between the attenuation coefficients and the ratio between the distances of propagation of the two position detection lights have a linear relationship, it is possible to obtain the positional information of the object Ob by setting the linear relationship in advance.

The ratio fa/fb between the attenuation coefficients is obtained as follows. For example, the light source 12A for position detection and the light source 12B for position detection are made to flash in opposite phase (for example, rectangular-wave or sine-wave drive signals are made to operate in such a way as to have a phase difference of 180 degrees at a frequency at which a phase difference due to the difference in distance of propagation can be ignored), and the waveforms of the amounts of detected light are analyzed. More practically, for example, one control variable Ia is fixed (Ia=Im) and the other control variable Ib is controlled so that the detection waveform cannot be observed, that is, the ratio Ga/Gb between the amounts of detected light becomes 1. Based on the control variable Ib=Im·(fa/fb) at this time, the ratio fa/fb between the attenuation coefficients is derived.

Moreover, the control may be performed in such a way that the sum of the two control variables becomes always constant, that is, the following equation: Im=Ia+Ib is satisfied. In that case, since the following equation: Ib=Im·fa/(fa+fb) holds, when fa/(fa+fb)=a holds, the ratio between the attenuation coefficients is obtained from fa/fb=α/(1−α).

Therefore, the positional information of the object Ob in the direction of the arrow A can be obtained by driving the light source 12A for position detection and the light source 12B for position detection in opposite phase. Moreover, the positional information of the object Ob in the direction of the arrow B can be obtained by driving the light source 12C for position detection and the light source 12D for position detection in opposite phase. Thus, the positional coordinates of the object Ob on the XY plane can be obtained by sequentially performing the detection operations in the directions of the arrows A and B in the control system.

As described above, when the planar positional information of the object Ob in the detection area 10R is obtained based on the ratio between the amounts of the position detection light detected by the light receiving element 15, a configuration in which, for example, a microprocessor unit (MPU) is used as a signal processing section and processing is performed by executing predetermined software (an operating program) by the microprocessor unit (MPU) can be adopted. In addition, a configuration in which processing is performed by a signal processing section using hardware such as a logic circuit can be adopted. Such a signal processing section may be incorporated in the display device 100 with a position detection function as part thereof, or may be configured in an electronic device equipped with the display device 100 with a position detection function.

Position Detection Method in this Embodiment

To detect the X coordinate position of the object Ob in the detection area 10R by the optical position detecting device 10 of this embodiment, the light sources 12A and 12D for position detection are driven in phase, the light sources 12B and 12C for position detection are driven in phase, and the light sources 12A and 12D for position detection and the light sources 12B and 12C for position detection are driven in opposite phase. That is, a first period in which an intensity distribution having a high exit intensity in one direction in the X-axis direction is formed by making the light sources 12A and 12D for position detection turn on and making the light sources 12B and 12C for position detection turn off and a second period in which an intensity distribution with a high exit intensity in the other direction of the X-axis direction is formed by making the light sources 12B and 12C for position detection turn on and making the light sources 12A and 12D for position detection turn off are set alternately. Therefore, by using the ratio or difference between the detected values of the light receiving element 15A in the first period and the second period in the position detecting section 450A of the signal processing section 450, it is possible to detect the X coordinate of the object Ob in one area 10Ra of the detection area 10R. Moreover, by using the ratio or difference between the detected values of the light receiving element 15B in the first period and the second period in the position detecting section 450B of the signal processing section 450, it is possible to detect the X coordinate of the object Ob in the other area 10Rb of the detection area 10R.

In addition, to detect the Y coordinate position of the object Ob in the detection area 10R, the light sources 12A and 12C for position detection are driven in phase, the light sources 12B and 12D for position detection are driven in phase, and the light sources 12A and 12C for position detection and the light sources 12B and 12D for position detection are driven in opposite phase. That is, a first period in which an intensity distribution with a high exit intensity in one direction in the Y-axis direction is formed by making the light sources 12A and 12C for position detection turn on and making the light sources 12B and 12D for position detection turn off and a second period in which an intensity distribution with a high exit intensity in the other direction in the Y-axis direction is formed by making the light sources 12B and 12D for position detection turn on and making the light sources 12A and 12C for position detection turn off are set alternately. Therefore, by using the ratio or difference between the detected values of the light receiving element 15A in the first period and the second period in the position detecting section 450A of the signal processing section 450, it is possible to detect the Y coordinate of the object Ob in one area 10Ra of the detection area 10R. Moreover, by using the ratio or difference between the detected values of the light receiving element 15B in the first period and the second period in the position detecting section 450B of the signal processing section 450, it is possible to detect the Y coordinate of the object Ob in the other area 10Rb of the detection area 10R.

As a result, it is possible to detect the XY coordinates of the object Ob in one area 10Ra of the detection area 10R and detect the XY coordinates of the object Ob in the other area 10Rb. Therefore, as shown in FIG. 1A, even when the users bring fingers or the like close to the screen member 220 in the two areas 10Ra and 10Rb concurrently, it is possible to detect the positions where the fingers or the like are brought close to the two areas 10Ra and 10Rb.

Incidentally, the Z coordinate may be detected by forming an intensity distribution of the position detection lights in the Z-axis direction by making the four light sources 12A to 12D for position detection flash concurrently. In this case, the use of the detected values of the light receiving element 15A makes it possible to detect the Z coordinate of the object Ob in one area 10Ra of the detection area 10R. Moreover, the use of the detected values of the light receiving element 15B makes it possible to detect the Z coordinate of the object Ob in the other area 10Rb of the detection area 10R.

### Main Effect of this Embodiment

As described above, in the optical position detecting device 10 and the display device 100 with a position detection function of this embodiment, the position detection lights L2a to L2d exit from the light exit surface 13s of the light guide plate 13, and, when the position detection lights L2a to L2d are reflected from the object Ob placed on the exit side of the light guide plate 13, the reflected light is detected by the light receiving element 15. Here, since the intensity of the position detection lights L2a to L2d in the detection area 10R and the distance from the light sources 12A to 12D for position detection have a predetermined correlation, it is possible to detect the XY coordinates of the object Ob based on the intensity of the received light obtained via the light receiving element 15. Moreover, since this detection method only requires to form a light intensity distribution of the position detection light on the screen surface 220s side of the screen member 220, there is no need to dispose the light guide plate 13 on the front side of the screen member 220. Thus, this method is suitable for configuring the display device 100 with a position detection function, the display device 100 which displays an image on the screen member 220.

Moreover, this embodiment uses the screen device 210 in which the light receiving element 15 (the light receiving elements 15A and 15B) is fixed to the screen device main body 230 provided with the screen member 220 on which an image is formed. As a result, even when a relatively large image area such as the screen member 220 is provided, since the light receiving element 15 is fixed to the screen device main body 230 itself in advance, it is possible to secure a high degree of positional accuracy between the screen member 220 and the light receiving element 15 without much trouble when the display device 100 with a position detection function is assembled.

In addition, the screen member 220 allows the infrared light to pass therethrough, and the position detection lights L2a to L2d are infrared lights which pass through the screen member 220 from the back face 220t side of the screen member 220 and travel to the screen surface 220s side thereof. As a result, even when the light source 12 for position detection is provided on the screen member 220 on the side (the other surface side) thereof opposite from the input operation side, it is possible to form a light intensity distribution of the position detection light on the screen surface 220s side of the screen member 220. Therefore, this embodiment has an advantage in that there is no need to provide the light source 12 for position detection or the like in the screen member 220 on the input operation side (the screen surface 220s side) thereof.

Moreover, in this embodiment, a plurality of light receiving elements 15A and 15B are used, and the light receiving elements 15A and 15B direct the light receiving sections 151 to different areas in the screen surface 220s of the screen member 220. This makes it possible to perform position detection by dividing the area by the plurality of light receiving elements 15A and 15B. Therefore, it is possible to perform position detection reliably on the screen surface 220s side of a wide image display area such as a screen member 220.

Furthermore, the screen surface 220s is rectangular, and the light receiving elements 15A and 15B are provided in different positions in the long side direction in an outside area next to the long side 220b of the screen surface 220s. As a result, in both of the areas 10Ra and 10Rb monitored by the light receiving elements 15A and 15B, the distances from the light receiving elements 15A and 15B are short. Thus, since an adequate amount of position detection light enters the light receiving elements 15A and 15B, it is possible to reduce detection errors. In addition, since the plurality of light receiving elements 15A and 15B are provided in an area corresponding to the same long side 220b of the screen surface 220s, the light receiving elements 15A and 15B can be provided so as to be situated close to each other. This makes it possible to dispose the wiring material 36 for the light receiving elements 15A and 15B in a narrow area.

### Structure of Another Light Source Device for Position Detection

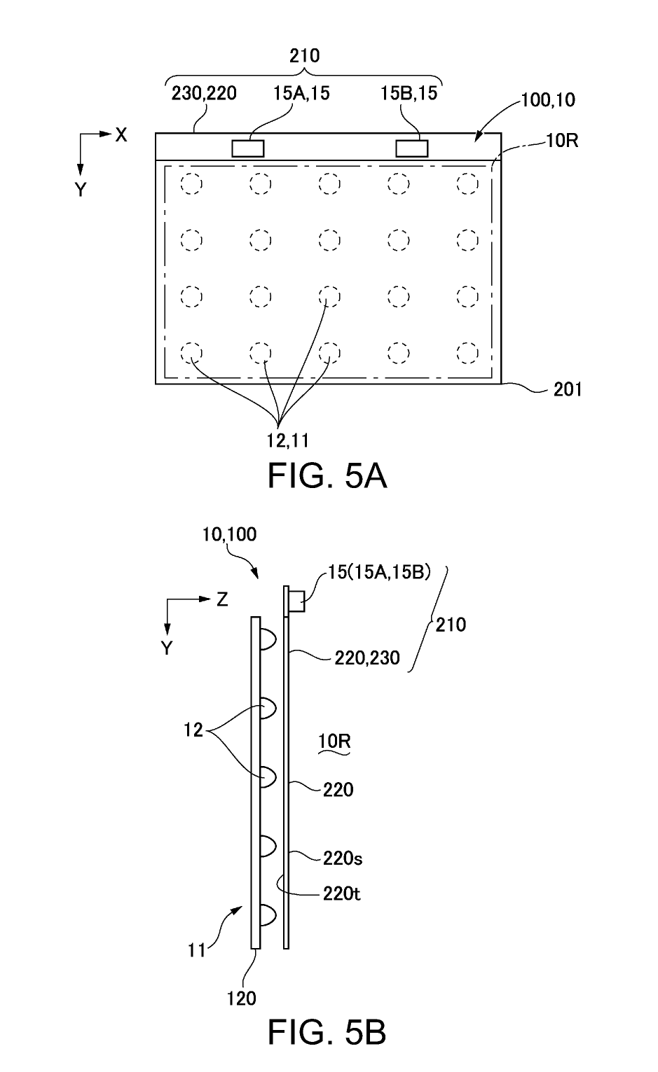

FIGS. 5A and 5B are explanatory diagrams of another light source device 11 for position detection used in the optical position detecting device 10 to which the invention is applied.

In the above-described embodiment, the light guide plate 13 is used as the light source device 11 for position detection. However, as shown in FIGS. 5A and 5B, a light source device 11 for position detection which is provided with a substrate 120 on which a plurality of light sources 12 for position detection are arranged in positions facing the detection area 10R in the Z-axis direction on the back face side of the screen member 210 and includes no light guide plate may be adopted.

Also in such a structure, by making, of the plurality of light sources 12 for position detection, only one of the light sources 12 for position detection spaced in the X direction turn on when the X coordinate position of the object Ob is detected, it is possible to form an intensity distribution of the position detection light. Moreover, by making, of the plurality of light sources 12 for position detection, only one of the light sources 12 for position detection spaced in the Y direction turn on when the Y coordinate position of the object Ob is detected, it is possible to form an intensity distribution of the position detection light.

### Other Embodiments

The above-described embodiment deals with the screen device 210 having the screen device main body 230 to which the two light receiving elements 15 (the light receiving elements 15A and 15B) are fixed. However, the invention may be applied to a case in which one light receiving element 15 or three or more light receiving elements 15 are used.

In the above-described embodiment, the invention is applied to the horizontally oriented screen member 220.

However, the invention may be applied to a case in which a vertically oriented screen member 220 is used.

In the above-described embodiment, the light source device 11 for position detection is disposed on the back face 220t side of the screen member 220. However, the light source device 11 for position detection may be disposed on the screen surface 220s side of the screen member 220.

In the above-described embodiment, the invention is applied to a screen device used in a projection display device. However, the invention may be applied to a screen device used in an electronic blackboard.

The entire disclosure of Japanese Patent Application No. 2009-215378, filed Sep. 17, 2009 is expressly incorporated by reference herein.

What is claimed is:

1. A screen device with a light receiving element, the screen device being used in a display device with a position detection function, the display device forming an intensity distribution of a position detection light on a screen surface side of a screen member, the screen surface side on which an image is visually recognized, the display device detecting the position of an object located on the screen surface side of the screen member by detecting the position detection light reflected from the object, the screen device comprising:
a screen device main body provided with the screen member; and
a light receiving element which is formed of a photodiode or a phototransistor fixed to the screen device main body and directs a light receiving section in a direction along the screen surface outside a screen surface in a state in which the screen member is spread.

2. The screen device with a light receiving element according to claim 1, wherein
the screen member passes an infrared light therethrough, and
the position detection light is an infrared light passing through the screen member from a back face side of the screen member and traveling to the screen surface side.

3. The screen device with a light receiving element according to claim 1, wherein
the screen device comprises a plurality of light receiving elements, and
the plurality of light receiving elements direct the light receiving sections to different areas in the screen surface.

4. The screen device with a light receiving element according to claim 3, wherein
the screen surface is rectangular, and
the plurality of light receiving elements are provided in different positions in a long side direction of the screen surface in an area next to a long side of the screen surface.

5. The screen device with a light receiving element according to claim 4, wherein
the plurality of light receiving elements are provided in an area next to the same long side of the screen surface.

6. The screen device with a light receiving element according to claim 1, wherein
the screen member has flexibility.

7. The screen device with a light receiving element according to claim 1, wherein
the light receiving element is fixed to the screen surface side of the screen member.

8. The screen device with a light receiving element according to claim 6, wherein
the screen device main body includes a rolling-up device rolling up the screen member and a housing in which the rolling-up device is stored, and
the light receiving element is fixed to the housing.

9. A display device with a position detection function, the display device provided with the screen device with a light receiving element according to claim 1, the display device comprising:
a light source device for position detection forming an intensity distributions of the position detection light in directions intersecting one another at different times on the screen surface side of the screen member; and
a position detecting section detecting the position of the object based on a light reception result obtained by the light receiving element.

10. A display device with a position detection function, the display device provided with the screen device with a light receiving element according to claim 3, the display device comprising:
a light source device for position detection forming an intensity distributions of the position detection light in directions intersecting one another at different times on the screen surface side of the screen member; and
a position detecting section detecting the position of the object based on light reception results of the plurality of light receiving elements, the object including a plurality of objects.

11. The display device with a position detection function according to claim 9, wherein
the light source device for position detection includes a plurality of light sources for position detection, the light sources emitting the position detection light on the back face side of the screen member which has been spread, and a light guide plate disposed on the back face side of the screen member which has been spread, the light guide plate taking in the light emitted from the light sources for position detection and making the light travel to the screen member.
